(19) United States
(12) Patent Application Publication
(10) Pub. No.: US 2005/0201393 A1
(43) Pub. Date: Sep. 15, 2005

(54) Server apparatus, network-based appliance, and program product

(75) Inventors: Yoshinori Hatayama, Komaki City (JP); Shinichi Ohnaru, Higash-osaka City (JP); Toshiyuki Hirata, Otsu-city (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/064,835

(22) Filed: Feb. 25, 2005

(30) Foreign Application Priority Data
Feb. 26, 2004 (JP) 2004-51599 (P)

(51) Int. Cl. H04L 12/28

(52) U.S. Cl. 370/401

(57) ABSTRACT

An object of the present invention is to set a wireless LAN communication parameter with respect to an appliance connected to an in-home network smoothly and easily. Prior to purchasing an appliance, a user registers an in-home network in a center server, and receives a user ID and an e-mail address. Thereafter, when the user purchases an appliance from a vendor by presenting his/her own user ID, a user ID and a device encryption key of the appliance are transmitted from the vendor to the center server. The center server transmits the received information to an e-mail address (home server) of the user ID. The home server searches for a corresponding appliance in an ad hoc mode using the received device encryption key. At this time, when the purchased appliance has already been on the network, communication is established, and a user encryption key (wireless communication parameter) is given from the home sever to the appliance.

### BACKGROUND OF THE INVENTION

1. Field of the Invention

The present invention relates to a server apparatus, a network-based appliance, and a program product, and more particularly to a server apparatus, a network-based appliance, and a program product preferably used in an in-home network system using a wireless LAN as a transmission medium.

2. Description of the Related Art

In recent years, a wireless LAN is becoming mainstream as a transmission medium for an in-home network. In the case of using a wireless LAN as a transmission medium, it is necessary to set wireless LAN communication parameters (encryption key information such as an ESS-ID and a WEP key, etc.) required for wireless LAN communication on an appliance side, in participation in an in-home network.

However, in appliances of white goods such as a washing machine and a refrigerator, an input part for inputting such communication parameters with keys is not provided in most cases. In such a case, in order to set wireless LAN communication parameters while ensuring security, it is necessary to provide an input interface and a display apparatus separately on an appliance side. JP 2003-218875 A and JP 2003-229872 A describe an in-home network system in which such an input interface and display apparatus are provided.

However, providing the above-mentioned interface and display apparatus separately in white goods such as a washing machine and a refrigerator and a network adaptor that provides a function for a network to other household electric appliances only for the purpose of setting wireless LAN communication parameters is not a good idea in terms of cost and the like, and providing them may be difficult in terms of a shape and a use form.

### SUMMARY OF THE INVENTION

The present invention has an object to provide a network system capable of smoothly and easily setting wireless LAN communication parameters with respect to an appliance connected to a network, with which the above-mentioned problem is solved.

A first aspect of the present invention relates to a server apparatus for supplying information to an appliance connected to an internal network, including: a first communication means for communicating with an appliance via the internal network, using a first communication parameter set in the internal network; a second communication means for performing direct wireless communication with the appliance without using the internal network, using a second communication parameter set on an appliance basis; communication mode setting means for setting which of the first communication means and the second communication means is used for communication with the appliance; a third communication means for communicating with an external network; communication parameter obtaining means for obtaining the second communication parameter from the external network via the third communication means; communication parameter storing means for storing the second communication parameter obtained by the communication parameter obtaining means; and communication parameter transmitting means for transmitting the first communication parameter set in the internal network to an appliance on the internal network corresponding to the second communication parameter via the second communication means, using the second communication parameter obtained via the communication parameter obtaining means.

Further, the communication parameter transmitting means transmits a search command for searching for the appliance corresponding to the second communication parameter via the second communication means, using the second communication parameter obtained via the communication parameter obtaining means, and upon receiving a response to the search command, transmits the first communication parameter set in the internal network via the second communication means, using the second communication parameter obtained via the communication parameter obtaining means.

Further, when the communication parameter transmitting means does not receive a response to the search command, the communication parameter transmitting means transmits, to any of the appliances on the internal network, the second communication parameter obtained via the communication parameter obtaining means and a request command to the effect that the first communication parameter set in the internal network are set to the appliance corresponding to the second communication parameter.

Further, the server apparatus further includes parameter changing means for changing the first parameter set in the internal network, wherein the parameter changing means transmits the first parameter to be newly set via the second communication means, using the second communication parameter of each appliance stored in the communication parameter storing means.

A second aspect of the present invention relates to a network-based appliance connected to an internal network, including: communication parameter storing means for storing a first communication parameter set in the internal network; a first communication means for communicating with another appliance via the internal network, using the first communication parameter stored in the communication parameter storing means; a second communication means for performing direct wireless communication with another appliance without using the internal network, using a second communication parameter set on an appliance basis; communication mode setting means for setting which of the first communication means and the second communication means is used for communication with the appliance; communication parameter obtaining means for obtaining the second communication parameter of another appliance from a server apparatus on the internal network via the first communication means; and communication parameter transmitting means for transmitting the first communication parameter stored in the communication parameter storing means to an appliance on the internal network corresponding to the second communication parameter via the second communication means, using the second communication parameter obtained via the communication parameter obtaining means.

A third aspect of the present invention relates to a program product for providing a server apparatus with functions of the means according to the first aspect of the invention.

A fourth aspect of the present invention relates to a program product for providing functions of the means according to the second aspect of the invention to a computer for a network-based appliance connected to an internal network.

According to the above-mentioned aspects of the present invention, by connecting an appliance to an internal network, a first communication parameter set in the internal network can be set in the appliance automatically and smoothly.

Furthermore, in the case where a server apparatus cannot receive a response to a search command, another network-based appliance sets the first communication parameter in the appliance in place of the server apparatus. Therefore, even in the case where the server apparatus and the appliance are set in a range where radio waves do not reach and wireless communication cannot be performed, the first communication parameter can be set in the appliance smoothly.

Furthermore, a search command transmitted from the server apparatus can be received only by an appliance holding a corresponding second communication parameter, so that the communication between the server apparatus and the appliance can be considered as substantially one-to-one communication, and the first communication parameter required to be set finally can be set in a corresponding appliance while ensuring security.

### BRIEF DESCRIPTION OF THE DRAWINGS

The above-mentioned and other objects and novel features of the present invention will be completely apparent upon reading the following description of an embodiment mode with reference to the accompanying drawings in which:

FIG. 1 shows a configuration of a network system according to an embodiment mode of the present invention;

FIG. 2 shows functional blocks of a master node according to the embodiment mode of the present invention;

FIG. 3 shows functional blocks of a device node according to the embodiment mode of the present invention;

FIG. 4 is a diagram showing a general procedure flow according to a first embodiment of the present invention;

FIG. 5 is a processing flow chart at a time of setting a user encryption key according to the first embodiment of the present invention;

FIG. 6 is a processing flow chart at a time of setting a user encryption key according to a second embodiment of the present invention;

FIG. 7 is a processing flow chart at a time of setting a user encryption key according to the second embodiment of the present invention; and

FIG. 8 is a processing flow chart at a time of changing a user encryption key according to a third embodiment of the present invention.

### DETAILED DESCRIPTION OF THE PREFERRED EMBODIMENTS

Hereinafter, the present invention will be described by way of an embodiment mode with reference to the drawings. It should be noted that the following embodiment mode is given merely for illustrative purpose, and does not particularly limit the scope of the present invention.

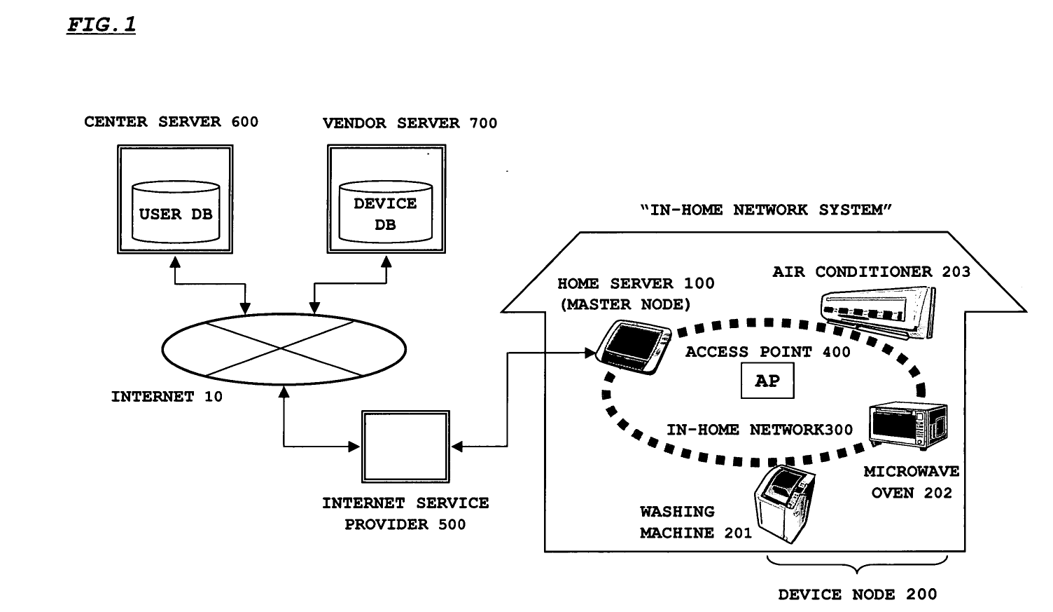

FIG. 1 shows a configuration of a network system according to an embodiment mode of the present invention. In FIG. 1, an in-home network 300 is configured through a wireless LAN in a home, and the in-home network 300 is connected to a home server 100, a washing machine 201, a microwave oven 202, and an air conditioner 203.

Herein, the home server 100, and the washing machine 201, the microwave oven 202, and the air conditioner 203 can perform many-to-many communication through an access point (AP) 400 provided on the in-home network 300. Furthermore, they can also communicate individually by transmitting/receiving radio waves without using the access point 400. These two communication forms respectively comply with an in-home network specification based on a wireless LAN. The former communication form is called an “infrastructure mode”, and the latter communication form is called an “ad hoc mode”.

Among them, in the “infrastructure mode”, communication is performed using a wireless LAN communication parameter (hereinafter, referred to as a “user encryption key”) previously set in the in-home network. In the “ad hoc mode”, communication is performed using a unique wireless LAN communication parameter (hereinafter, referred to as a “device encryption key”) allocated randomly on the appliance basis.

In this embodiment mode, communication is performed in the “ad hoc mode” using the device encryption key, whereby a wireless LAN communication parameter (user encryption key) set in the in-home network is given to an appliance newly connected to the in-home network.

In this embodiment mode, the above-mentioned device encryption key is allocated by a vendor that provides the appliance. For example, by adding a vendor ID varied on the vendor basis to higher-order n bits, the device encryption key unique among vendors is allocated to each appliance. Such a device encryption key is held in a memory (ROM, etc.) in the appliance. Furthermore, the device encryption key is stored as a part of device information of the appliance in a device DB of a vendor server 700 configured by the vendor on the Internet.

The home server 100 is connected to an Internet service provider (ISP) 500, for example, via a public network such as a telephone line. In addition, a center server 600, and the vendor server 700 configured by each vendor are connected to the Internet 10. Among them, the center server 600 has a user DB, and the user DB stores a transmission address of the user concerned (e-mail address: the home server 100 of the user is used as a transmission destination, etc.), and device information on an appliance which the user has purchased and obtained, under the condition that they are classified on the user ID basis.

Herein, the user ID is used for identifying an in-home network of each user, and is allocated from the center server 600 when an in-home network is configured in a home and registered in the center server 600. In the case where a user ID has already been set in the center server 600 (e.g., in the case where another service is provided), this user ID may be shared.

Furthermore, the transmission address is used for communication between the center server and the home server, and for example, is assigned from the center server 600 to the home server 100 at a time of registration in the center server 600. This address is different from that used by the user for exchanging an electronic mail separately. When communication is performed between the center server and the home server, encoding processing is performed by an encoding procedure preset between the center server 600 and the home server 100.

Furthermore, the device information is composed of attribute information (manufacturer name, model number, etc.) of the appliance concerned, and the above-mentioned device encryption key. Such device information is provided from the vendor server 700 to the center server 600 via the Internet 10 when the user has purchased the appliance.

The vendor server 700 is provided with a device DB that stores the above-mentioned device information (attribute information, device encryption key) under the condition that it is classified on the appliance basis. In this embodiment mode, when an appliance is purchased, a user ID is presented from the user to a vendor, and the presented user ID and specific information (ID) of the purchased appliance are input in the vendor server 700 as purchase information. In accordance with such an input, the vendor server 700 searches the device DB for device information on the purchased appliance, and transmits the searched device information and the input user ID to the center server 600. The center server 600 successively stores the received device information in the user DB in such a manner that the received device information is associated with the user ID. Consequently, device information on the appliance purchased by the user is successively stored in the user DB in the center server 600 under the condition that the device information is classified on the user ID basis.

When the center server 600 newly stores device information, the center server 600 transmits the device information to the home server 100 of the user. This transmission is performed, for example, on the e-mail protocol basis.

Upon receiving the device information, the home server 100 stores it, and broadcasts a search command (complying with an in-home network specification based on a wireless LAN) for searching for an appliance corresponding to the device information in an ad hoc mode using the above-mentioned device encryption key contained in the device information. At this time, when the corresponding appliance has already been connected to an in-home network, communication (ad hoc mode) is performed between the home server 100 and the appliance. Owing to such communication, the user encryption key is given to the appliance, and thereafter, the appliance can perform many-to-many communication (infrastructure mode) via the access point 400.

Hereinafter, user encryption key setting processing will be described in detail with reference to functional blocks of the home server 100 and the appliances 201 to 203. In the following description, the home server 100 is called a master node 100, and the washing machine 201, the microwave oven 202, the air conditioner 203, and other such household electric appliances are collectively called a device node 200.

### First Embodiment

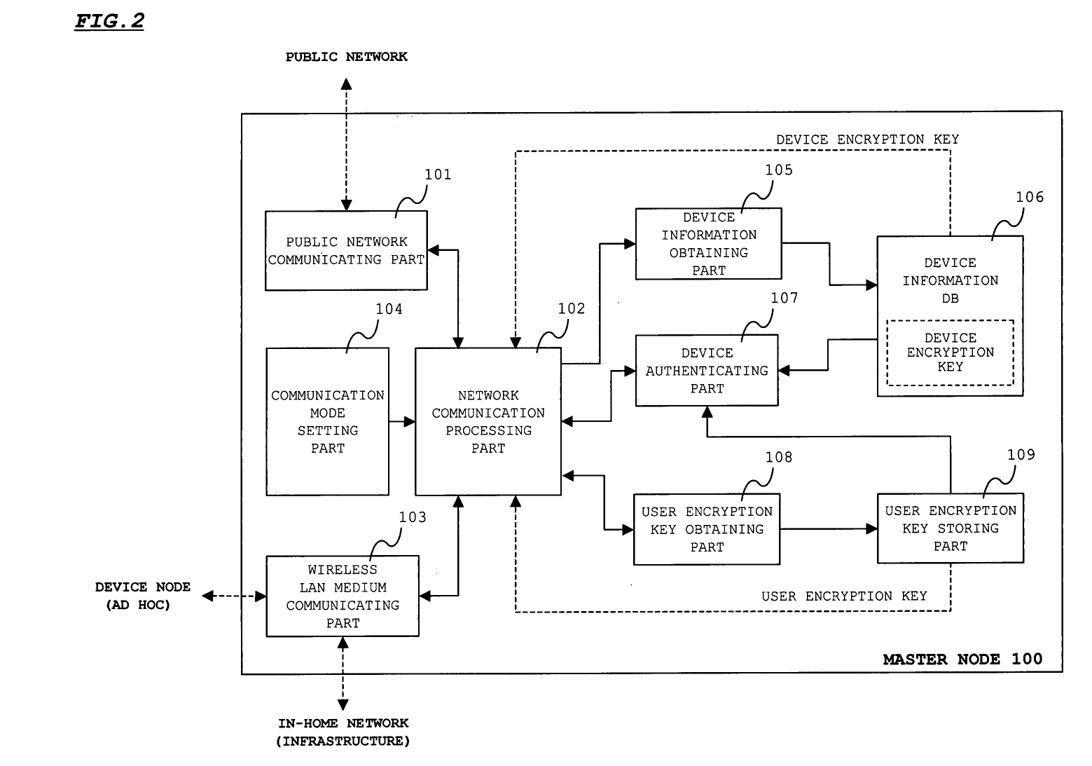

FIG. 2 shows functional blocks of the master node 100.

FIG. 2 shows only functional blocks required for giving a user encryption key. These functions can be realized by installing a program or a database for allowing a CPU to execute these functions in cooperation in the master node 100. The program or the database can be installed by a downloading method via a public network such as the Internet or a method for appropriately loading a storage medium (disk, etc.) storing the program or the database.

As shown in FIG. 2, the master node 100 includes a public network communicating part 101, a network communication processing part 102, a wireless LAN medium communicating part 103, a communication mode setting part 104, a device information obtaining part 105, a device information DB (database) 106, a device authenticating part 107, a user encryption key obtaining part 108, and a user encryption key storing part 109.

The public network communicating part 101 includes a communication interface such as a modem, and transmits/receives data with respect to a public network such as a telephone line. The network communication processing part 102 performs processing such as communication protocol processing with respect to data transmitted to/received from the public network communicating part 101 and the wireless LAN medium communicating part 103. The wireless LAN medium communication processing part 103 includes a wireless communication interface such as a wireless module, and performs wireless communication with respect to the device node 200. The communication mode setting part 104 sets a communication mode (infrastructure mode/ad hoc mode) during wireless LAN communication to the network communication processing part 102.

The device information obtaining part 105 obtains device information from e-mail data from the center server 600, received via the public network communicating part 101, and stores the device information in the device information DB 106. The device information DB 106 successively stores the obtained device information under the condition that the device information is classified on the appliance basis.

The device authenticating part 107 authenticates an appliance newly connected to the in-home network 300, and transmits a user encryption key stored in the user encryption key storing part 109 in accordance with the authentication to the appliance, as described later.

The user encryption key obtaining part 108 obtains a user encryption key set in the in-home network, and stores it in the user encryption key storing part 109. The user encryption key is set appropriately by a user, for example, via an operation terminal (not shown) connected on the in-home network 300. Such setting is performed when a user inputs required information with respect to a GUI (Graphic User Interface) displayed on an operation terminal.

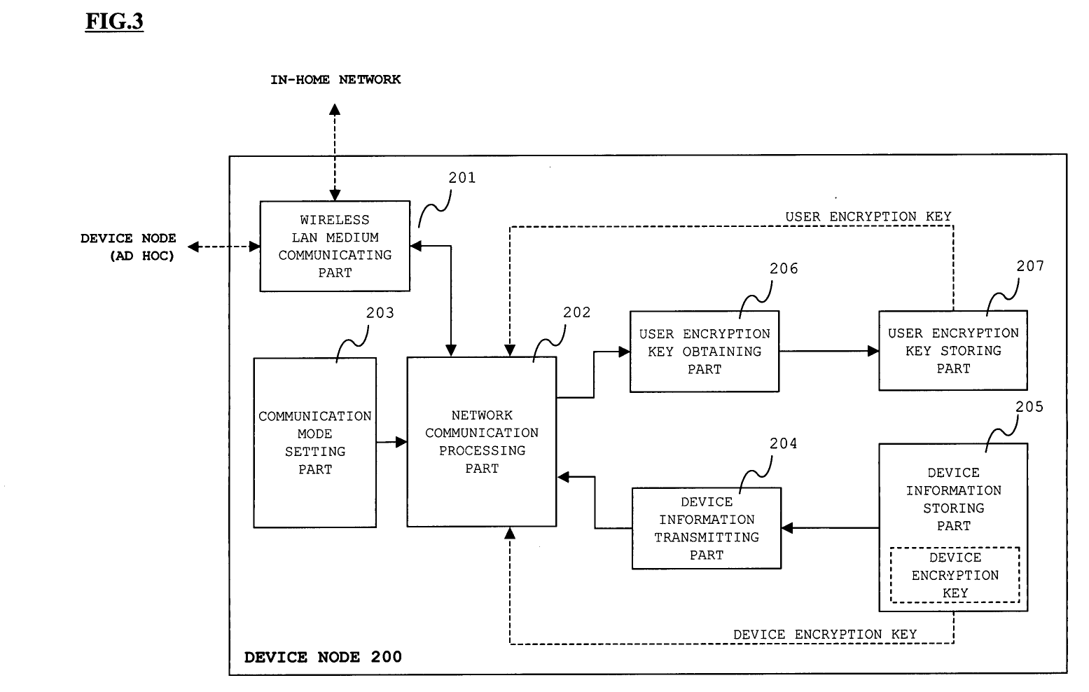

FIG. 3 shows functional blocks of a device node 200.

FIG. 3 shows only functional blocks required for giving a user encryption key. These functions can be realized, for example, by installing a program or a database for allowing a CPU to execute these functions in cooperation in the device node 200 in the same way as the above.

As shown in FIG. 3, the device node 200 includes a wireless LAN medium communicating part 201, a network communication processing part 202, a communication mode setting part 203, a device information transmitting part 204, a device information storing part 205, a user encryption key obtaining part 206, and a user encryption key storing part 207.

The wireless LAN medium communication processing part 201 includes a wireless communication interface such as a wireless module, and performs wireless communication with respect to the master node 200 or another device node. The network communication processing part 202 subjects data, which is transmitted/received with respect to the wireless LAN medium communicating part 201, to communication protocol processing, for example. The communication mode setting part 203 sets a communication mode (infrastructure mode/ad hoc mode) during wireless LAN communication in the network communication processing part 202.

The device information transmitting part 204 reads device information stored in the device information storing part 205, and transmits the device information to the master node 100 via the network communication processing part 202. The device information storing part 205 stores appliance information (manufacturer name, model number, etc.) on the appliance concerned, and a device encryption key of the appliance allocated by a device vendor. The user encryption key obtaining part 206 obtains a user encryption key from data received from the master server 100 via the wireless LAN medium communicating part 201, and stores the user encryption key in the user encryption key storing part 207.

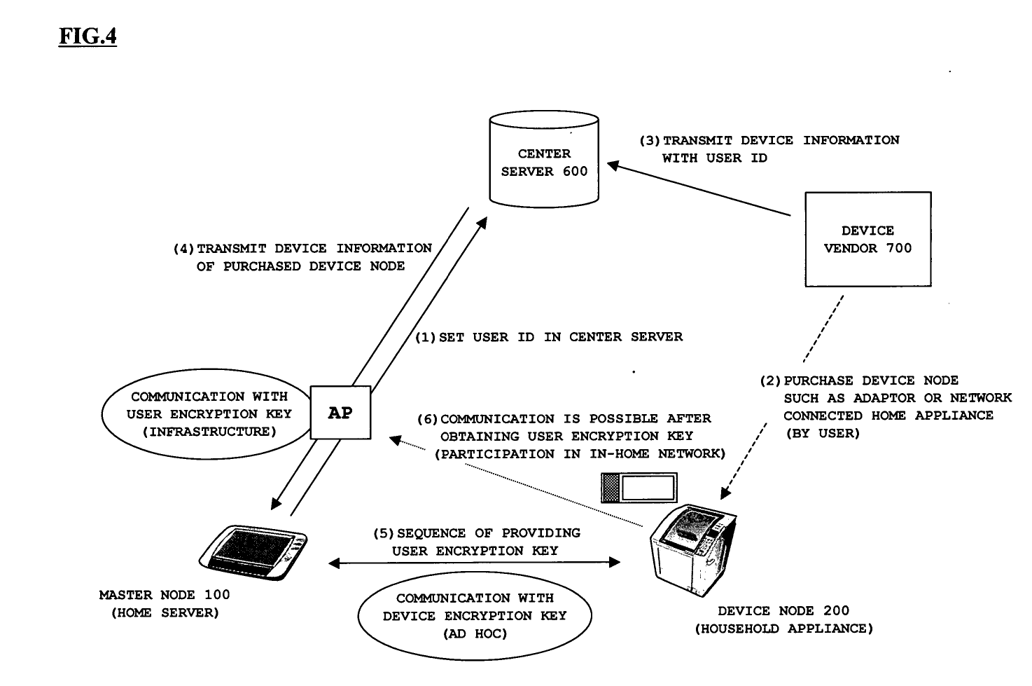

FIG. 4 schematically shows a procedure flow in this embodiment. The numerals shown in FIG. 4 represent a processing order in the procedure flow. In the following description, procedures are described as (Step 1) to (Step 6).

First, prior to purchasing an appliance, a user configures an in-home network in a home and registers it in the center server 600, and receives a user ID and an e-mail address from the center server 600. Simultaneously, the user sets a user encryption key with respect to the in-home network (Step 1).

After that, when the user purchases a device node from a vendor by presenting his/her own user ID (Step 2), the user ID and an ID of the purchased appliance are input in the device vendor 700. Consequently, the user ID and the device information of the device node are transmitted from the device vendor 700 to the center server 600 via the Internet (Step 3).

The center server 600 stores the received device information in a user DB, and transmits the device information to the e-mail address of the user ID (master node 100) (Step 4).

The master node 100 stores the received device information in the device information DB 106, and broadcasts a search command for searching for an appliance corresponding to the device information in an ad hoc mode, using the device encryption key contained in the device information received from the center server 600 (Step 5). At this time, when the purchased device node 200 has already been connected to the in-home network, communication (ad hoc mode) between the master node 100 and the device node 200 becomes possible, and the user encryption key is given from the master node 100 to the device node 200 through this communication. Consequently, the device node 200 obtains a user encryption key, and thereafter, becomes capable of performing communication in an infrastructure mode via the access point (AP (Step 6).

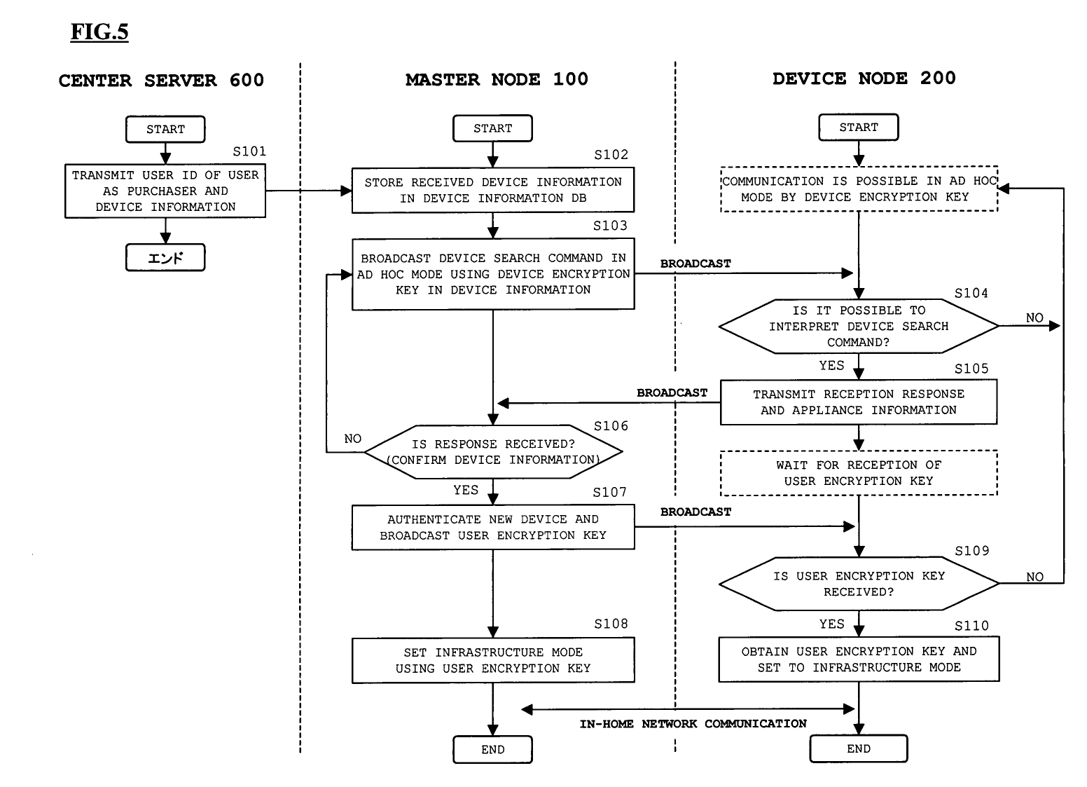

FIG. 5 shows a processing flow of the processing performed in the center server 600, the master node 100, and the device node 200 in or after Step 4 above.

When the user ID of the user who has purchased the device node and the device information are transmitted from the vendor server 700 to the center server 600, the device information is stored in the device DB of the center server 600, and transmitted to the e-mail address corresponding to the user ID (S101). Upon receiving this, the master node 100 stores the received device information in the device information DB 106 (S102), and broadcasts a search command for searching for an appliance corresponding to the device information in a ad hoc mode, using the device encryption key (hereinafter, referred to as a “new device encryption key”) contained in the device information (S103).

At this time, when the corresponding device node 200 (hereinafter, referred to as a “new device node”) has already been connected to the in-home network, the new device node 200 is set in an ad hoc mode during the connection to the in-home network, so that the new device node 200 can receive/interpret the search command broadcast from the master node 100 with the device encryption key in the device information stored in the device information storing part 205 (S104: YES). In accordance with this, the new device node 200 broadcasts the received response to the search command in an ad hoc mode using its own device encryption key. Furthermore, the new device node 200 broadcasts the device information stored in the device storing part 205 in an ad hoc mode using its own device encryption key, in accordance with a request from the master node 100 (S105).

Such a broadcast is received/interpreted with the new device encryption key stored in the device information DB 106 of the master node 100. At this time, the device authenticating part 107 of the master node 100 compares the received device information with device information (received in S102) stored in the device information DB 106, and when confirming that they are matched, the device authenticating part 107 allows the participation of the new device node 200 in the in-home network 300 through authentication (S106: YES). Then, after the authentication, the device authenticating part 107 reads a user encryption key stored in the user encryption key storing part 109, sets the read user encryption key in a parameter setting command (complying with the in-home network specification based on a wireless LAN), and broadcasts it in an ad hoc mode based on a new device encryption key (S107). Then, the master node 100 sets the communication mode with respect to the new device node in an infrastructure mode using a user encryption key (S108).

The parameter setting command is received/interpreted by the new device node 200 (S109: YES), the new device node 200 obtains a user encryption key from the received parameter setting command (user encryption key obtaining part 206), and stores it in the user encryption key storing part 207. Then, the new device node 200 sets its own communication mode in an infrastructure mode using a user encryption key (S110).

As a result of the above processing, the user encryption key is set in the new device node 200, whereby the new device node becomes capable of communicating with each node on the in-home network 300 via a wireless LAN transmission medium while using a user encryption key. Thereafter, an IP address is set and the like by plug-and-play processing for the in-home network, and participation processing of the new device node with respect to the in-home network 300 is completed.

Whether or not the new device node 200 was able to participate in the in-home network may be confirmed by a method of turning on an LED of the device node 200 or the like.

According to this embodiment, only by connecting a new device node to the in-home network 300, a user encryption key of the in-home network can be set in the new device node automatically and smoothly. At this time, a search command broadcast from the master node 100 can be received/interpreted only by the device node 200 holding a corresponding device encryption key. Therefore, such communication can be considered as substantially one-to-one communication, and a user encryption key required to be set finally can be set in the new device node 200 while ensuring security. Furthermore, the device authenticating part 107 authenticates a device node (device node purchased by the user) corresponding to the device information transmitted from the center server 600 as a device node allowed to participate in the in-home network 300. Therefore, for example, a device node obtained without authorization can be suppressed from being connected to the in-home network, and the use of a device node without authorization can also be prevented.

Thus, according to this embodiment, a user encryption key can be set in a new device node by a simple procedure, and it is possible to ensure security during setting of a user encryption key and avoid the use of a device node without authorization simultaneously.

### Second Embodiment

In the above-mentioned first embodiment, a search command is broadcast through radio waves (ad hoc mode), so that it is necessary that the new device node 200 and the master node 100 be provided in a range where radio waves reach directly. However, there may be a setting form in which the new device node 200 and the master node 100 are provided in such a manner that radio waves do not reach directly, e.g., the case where the new device node 200 and the master node 100 are provided respectively on the first and third floors. In such a case, in the first embodiment, it is impossible to set a user encryption key in the new device node 200. This embodiment overcomes such inconvenience.

In this embodiment, a search function of a new device node in the above first embodiment and a function of giving a user encryption key are distributed to the device node 200 that has already been connected to an in-home network. More specifically, the function of the device authenticating part 107 shown in FIG. 2 is given to the corresponding device node. Such a function may be provided to the device node 200 in advance or may be downloaded from the master node 100 to the device node 200 if required. Furthermore, it is not necessary to distribute the function to all the device nodes, and for example, the function may be distributed to several device nodes on each floor. In this case, a user may appropriately determine which device nodes the function is distributed to. It is necessary to separately set and register data about which device nodes the function is distributed to in the master node 100.

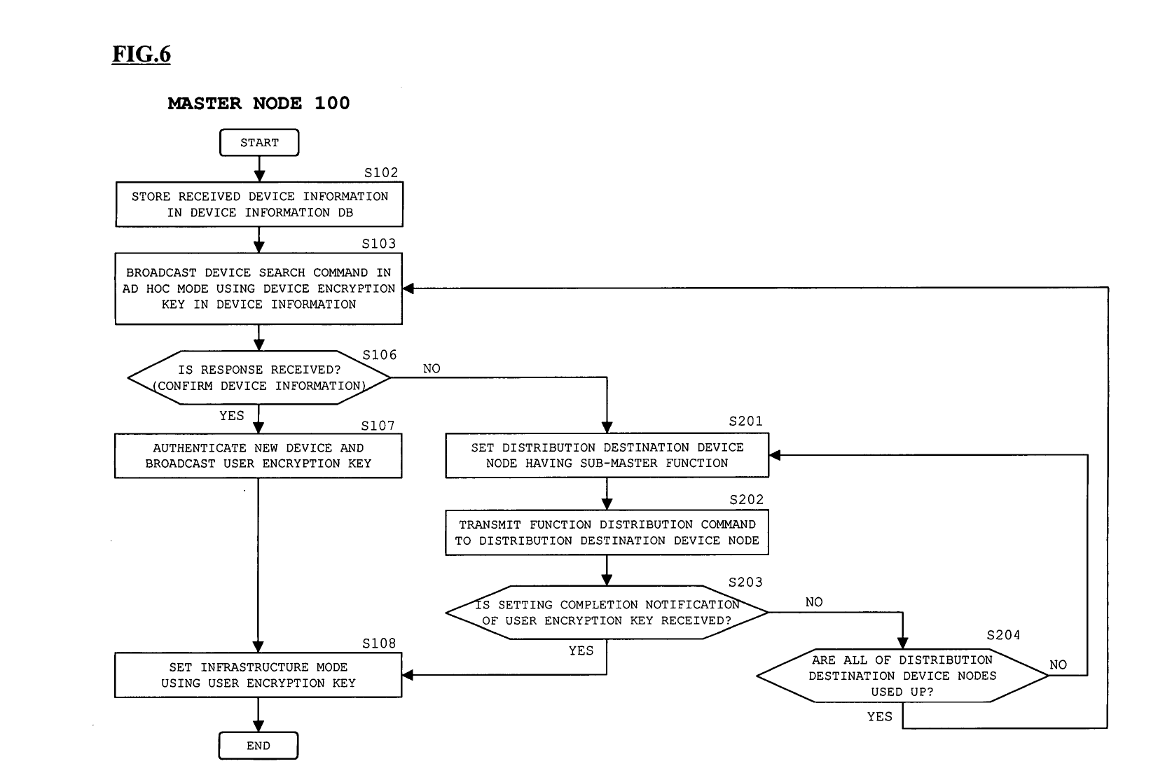

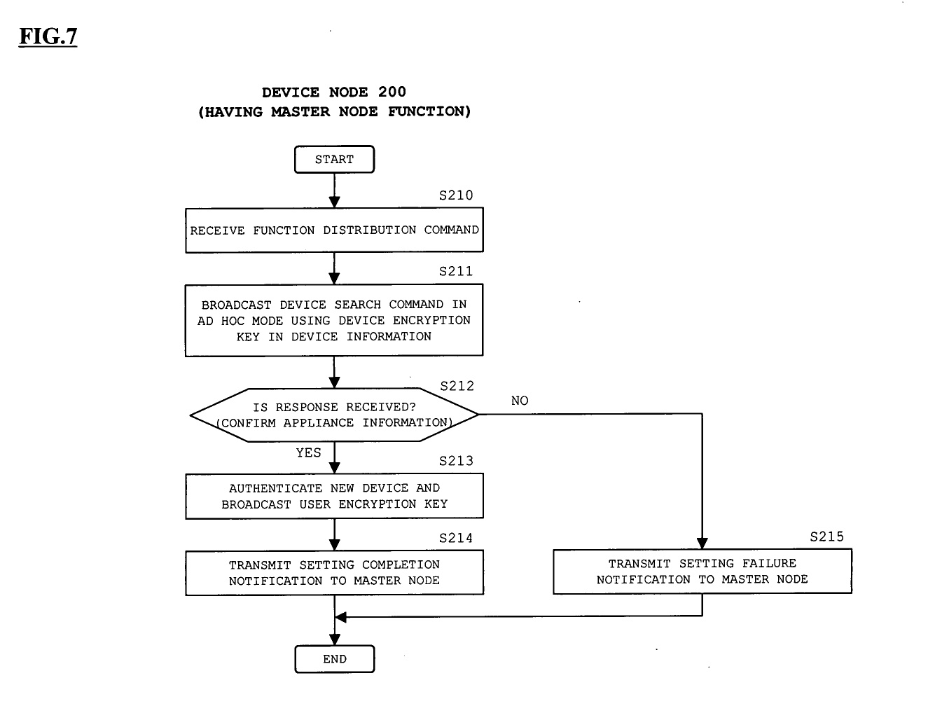

FIGS. 6 and 7 show a processing flow when a user encryption key is given in this embodiment. In the processing flow, it is assumed that device nodes to which the function is to be distributed have already been provided with the function of the device authenticating part 107. Furthermore, it is assumed that data about which device nodes the function is distributed to is registered in the master node 100.

In the processing flow of the master node 100 in FIG. 6, processing in S102 to S108 is the same as those in the above first embodiment. More specifically, when there is a response to the search command from the master node 100 from the new device node 200, a user encryption key is given from the master node 100 to the new device node 200 in the same way as in the above.

In contrast, if there is no response to the search command (S106: NO), one device node among the device nodes to which the function is distributed is set as a distribution destination device node (S201), and a function distribution command is transmitted to the distribution destination device node 200 in an infrastructure mode (S202). Such a function distribution command contains device information (attribute information, new device encryption key) of the new device node 200.

Referring to FIG. 7, upon receiving the function distribution command from the master node 100 (S210), the distribution destination device node broadcasts a search command for searching for a new device node in an ad hoc mode, using a new device encryption key contained in device information in the function distribution command (S211).

After that, when a response is received from the new device node, and the device information received from the new device node is matched with the device information received from the master node 100 (S212: YES), the new device node is authenticated as a device node allowed to be connected to the in-home network. Then, a user encryption key stored in the user encryption key storing part 207 is read, and the read user encryption key is broadcast in an ad hoc mode based on a new device encryption key, under the condition of being included in a parameter setting command (S213). Thereafter, a response to such a parameter setting command is received from the new device node 200, a setting completion notification of a user encryption key is transmitted to the master node 100(214).

On the other hand, in the case where a response to the broadcast of the search command cannot be received from the new device node 200 or the device information received from the new device node does not match with the device information received from the master node 100 (S212: NO), the distribution destination device node 200 transmits a setting failure notification showing the fact that a user encryption key cannot be set to the master node 100 (S215).

Referring back to FIG. 6, upon receiving the setting completion notification of a user encryption key from the distribution destination device node 200 (S203: YES), the master node 100 sets a communication mode corresponding to the new device node to an infrastructure mode using a user encryption key (S108). On the other hand, upon receiving the setting failure notification of a user encryption key from the distribution destination device node 200 (S203: NO), the master node 100 sets a subsequent device node among the device nodes to which the function is distributed as a distribution destination device node (S204→S201), and allows the subsequent distribution destination device node to perform a distribution function by the processing similar to that as described above.

The function distribution processing is repeated until the setting completion notification of a user encryption key is received from the distribution destination device node 200 (S203: YES), or function distribution processing is performed through all the device nodes to which the function is distributed (S204: YES). Then, if a user encryption key cannot be set even when the function distribution processing is performed through all the device nodes to which the function is distributed, the process returns to S103, and the subsequent processing is repeated. There is a high possibility that even when the processing after returning to S103 is performed immediately, a user encryption key cannot be set (a new device node is not connected to the in-home network). Therefore, the processing after returning to S103 may be performed after the elapse of a predetermined period of time. This can avoid unnecessary processing.

As described above, according to this embodiment, even in the case where the new device node 200 and the master node 100 are not provided in a range where radio waves reach directly, a user encryption key can be set smoothly with respect to the new device node 200.

### Third Embodiment

This embodiment relates to processing in changing a user encryption key that has already been set.

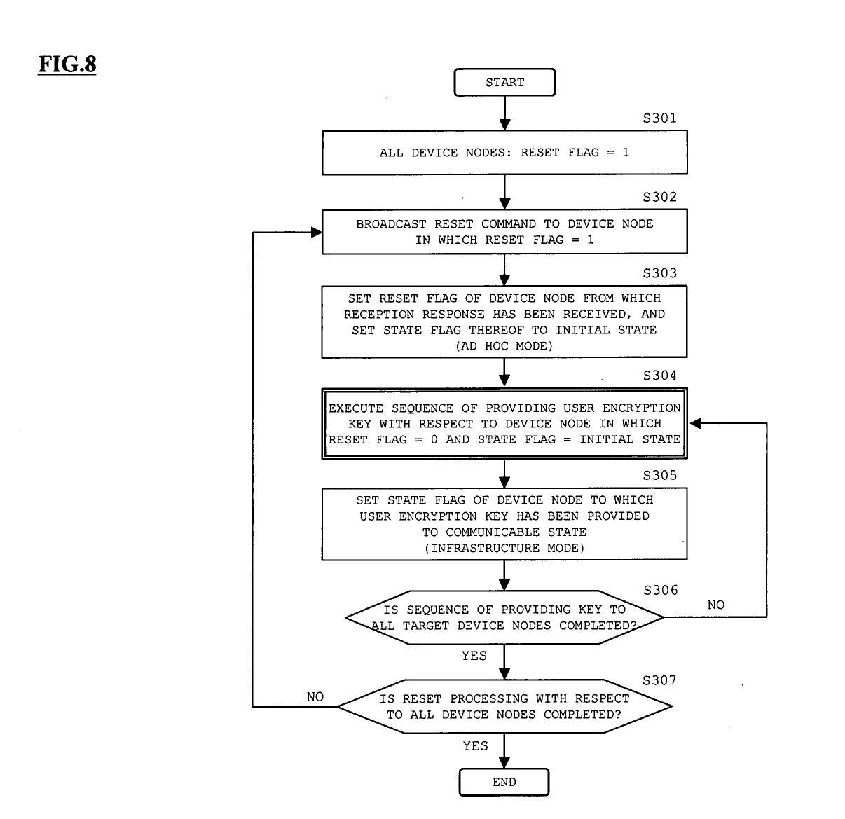

FIG. 8 shows a processing flow of the master node 100 according to this embodiment.

When a user inputs an instruction of changing a user encryption key and a new user encryption key by operating an operation terminal, the master node 100 sets reset flags of all the device nodes stored in the device information DB 106 to “1” (S301), and broadcasts a reset command in an infrastructure mode designating to all the device nodes (device nodes in which reset flag=1) (S302). The device node 200 having received such a reset command transmits a reception response of the reset command to the master node 100 in an infrastructure mode, and thereafter, erases the user encryption key stored in its own user encryption key storing part 207, and switches a communication mode to an ad hoc mode based on its own device encryption key.

Upon receiving the reception response of the reset command from the device node 200, the master node 100 sets a reset flag of the device node 200 to “0”. Then, the master node 100 sets a communication state flag of the device node from a “communicable state (infrastructure mode)” to an “initial state (ad hoc mode)” (S303). Regarding the device nodes from which a reception response has not been received within a predetermined period of time, the reset flag is held “1”, and the communication state flag is held in a “communicable state (infrastructure mode)”.

Thereafter, the master node 100 sets a new user encryption key (ad hoc mode) with respect to the device node in which the reset flag is “0” and the state flag is in an “initial state”, in accordance with the processing flows shown in FIG. 5 or 6, and 7, thereby setting the communication state flag of the device node in which a new user encryption key is set to the “communicable state” (S304). With such setting processing, as described in the first and second embodiments, a new user encryption key is set successively in the device node in which the reset flag is “0” and the state flag is in the “initial state”, and the communication mode with respect to the device node is set in an infrastructure mode. Such setting processing is performed until a new user encryption key is set with respect to all the target device nodes (S306).

Thus, when the setting of a new user encryption key with respect to all the device nodes 200 in which the reset flag is “0” and the state flag is in the “initial state” is completed (S306: YES), a new user encryption key is set in the in-home network, after which communication (infrastructure mode) using such an encryption key is performed.

In the case where a reception response to the reset command from all the device nodes on the in-home network cannot be received in S303 (S307: NO), the process returns to S302, and a reset command is broadcast in an infrastructure mode to the device nodes from which a reception response cannot be received. Such a broadcast is performed using an old user encryption key before a new user encryption key is set. There is a high possibility that even when the processing after returning to S302 is performed immediately, a user encryption key cannot be set (a target device node is temporarily separated from the in-home network), so that the processing after returning to S302 may be performed after the elapse of a predetermined period of time. This can avoid useless processing.

According to this embodiment, a processing flow of a user encryption key with respect to a new device node can be partially used for processing of changing a user encryption key, so that the processing sequence in changing a user encryption key can be simplified. Furthermore, a new user encryption key is set in one-to-one communication in a corresponding device node in an ad hoc mode, using a device encryption key corresponding to each device node, in the same way as in the first and second embodiments. Therefore, a new user encryption key can be set in each device node while ensuring security, and a new user encryption key cannot be set in device nodes other than a device node (device node purchased by a user) corresponding to device information transmitted from the center server 600, so that, for example, a device node obtained without authorization can be suppressed from participating in the in-home network.

In any of the above embodiments, in the case where device information held by the master node 100 is lost, the device information is managed in the user DB of the center server 600, so that the device information can be obtained again therefrom.

The embodiment mode of the present invention has been described. However, the present invention is not limited to the embodiment mode. The embodiment mode of the present invention can be variously changed appropriately within the scope of the technical idea recited in the claims.

1. A server apparatus for supplying information to an appliance connected to an internal network, comprising:
a first communication means for communicating with an appliance via the internal network, using a first communication parameter set in the internal network;
a second communication means for performing direct wireless communication with the appliance without using the internal network, using a second communication parameter set on an appliance basis;
communication mode setting means for setting which of the first communication means and the second communication means is used for communication with the appliance;
a third communication means for communicating with an external network;
communication parameter obtaining means for obtaining the second communication parameter from the external network via the third communication means;
communication parameter storing means for storing the second communication parameter obtained by the communication parameter obtaining means; and
communication parameter transmitting means for transmitting the first communication parameter set in the internal network to an appliance on the internal network corresponding to the second communication parameter via the second communication means, using the second communication parameter obtained via the communication parameter obtaining means.

2. A server apparatus according to claim 1, wherein the communication parameter transmitting means transmits a search command for searching for the appliance corresponding to the second communication parameter via the second communication means, using the second communication parameter obtained via the communication parameter obtaining means, and upon receiving a response to the search command, transmits the first communication parameter set in the internal network via the second communication means, using the second communication parameter obtained via the communication parameter obtaining means.

3. A server apparatus according to claim 2, wherein:
the communication parameter obtaining means obtains appliance information on the appliance corresponding to the second communication parameter together with the second communication parameter from an external network; and
upon receiving a response to the search command, the communication parameter transmitting means further compares the appliance information received from the appliance transmitting the response with the appliance information obtained from the external network via the communication parameter obtaining means, and in a case where the appliance information obtained from the external network matches with the appliance information, the communication parameter transmitting means transmits the first communication parameter set in the internal network via the second communication means, using the second communication parameter obtained via the communication parameter obtaining means.

4. A server apparatus according to claim 2, wherein, when the communication parameter transmitting means does not receive a response to the search command, the communication parameter transmitting means transmits, to any of the appliances on the internal network, the second communication parameter obtained via the communication parameter obtaining means and a request command to the effect that the first communication parameter set in the internal network are set to the appliance corresponding to the second communication parameter.

5. A server apparatus according to any one of claims 1, 2, 3, and 4, further comprising parameter changing means for changing the first parameter set in the internal network,
wherein the parameter changing means transmits the first parameter to be newly set via the second communication means, using the second communication parameter of each appliance stored in the communication parameter storing means.

6. A network-based appliance connected to an internal network, comprising:
communication parameter storing means for storing a first communication parameter set in the internal network;
a first communication means for communicating with another appliance via the internal network, using the first communication parameter stored in the communication parameter storing means;
a second communication means for performing direct wireless communication with another appliance without using the internal network, using a second communication parameter set on an appliance basis;
communication mode setting means for setting which of the first communication means and the second communication means is used for communication with the appliance;
communication parameter obtaining means for obtaining the second communication parameter of another appliance from a server apparatus on the internal network via the first communication means; and
communication parameter transmitting means for transmitting the first communication parameter stored in the communication parameter storing means to an appliance on the internal network corresponding to the second communication parameter via the second communication means, using the second communication parameter obtained via the communication parameter obtaining means.

7. A program product for providing a server apparatus connected to an internal network with:
a first communication processing function for communicating with an appliance via the internal network, using a first communication parameter set in the internal network;
a second communication processing function for performing direct wireless communication with the appliance without using the internal network, using a second communication parameter set on an appliance basis;
a communication mode setting function for setting which of the first communication processing function and the second communication processing function is used for communication with the appliance;
a third communication processing function for communicating with an external network;
a communication parameter obtaining function for obtaining the second communication parameter from the external network via the third communication processing function;
a communication parameter storing function for storing the second communication parameter obtained by the communication parameter obtaining function in a memory; and
a communication parameter transmitting function for transmitting the first communication parameter set in the internal network to the appliance on the internal network corresponding to the second communication parameter by the second communication processing function, using the second communication parameter obtained by the communication parameter obtaining function.

8. A program product according to claim 7, wherein the communication parameter transmitting function includes a function of transmitting a search command for searching for the appliance corresponding to the second communication parameter by the second communication processing function, using the second communication parameter obtained via the communication parameter obtaining function, and upon receiving a response to the search command, transmitting the first communication parameter set in the internal network by the second communication processing function, using the second communication parameter obtained by the communication parameter obtaining function.

9. A program product according to claim 8, wherein:
the communication parameter obtaining function includes a function of obtaining appliance information on the appliance corresponding to the second communication parameter together with the second communication parameter from an external network; and
the communication parameter transmitting function further includes a function of, upon receiving a response to the search command, comparing the appliance information received from the appliance transmitting the response with the appliance information obtained from the external network by the communication parameter obtaining function, and in a case where the appliance information obtained from the external network matches with the appliance information, transmitting the first communication parameter set in the internal network by the second communication processing function, using the second communication parameter obtained by the communication parameter obtaining function.

10. A program product according to claim 8, wherein the communication parameter transmitting function includes a function of, when receiving no response to the search command, transmitting, to any of the appliances on the internal network, the second communication parameter obtained by the communication parameter obtaining function and a request command to the effect that the first communication parameter set in the internal network are set to the appliance corresponding to the second communication parameter.

11. A program product according to any one of claims 7, 8, 9, and 10, further-comprising a parameter changing function for changing the first parameter set in the internal network,
wherein the parameter changing function includes a function of transmitting the first parameter to be newly set by the second communication processing function, using the second communication parameter of each appliance stored in the memory.

12. A program product for providing a server apparatus having: a first communication processing function for communicating with an appliance via an internal network, using a first communication parameter set in the internal network; a second communication processing function for performing direct wireless communication with the appliance without using the internal network, using a second communication parameter set on an appliance basis; a communication mode setting function for setting which of the first communication processing function and the second communication processing function is used for communication with the appliance; and a third communication processing function for communicating with an external network, with:
a communication parameter obtaining function for obtaining the second communication parameter from the external network via the third communication processing function;
a communication parameter storing function for storing the second communication parameter obtained by the communication parameter obtaining function in a memory; and
a communication parameter transmitting function for transmitting the first communication parameter set in the internal network to the appliance on the internal network corresponding to the second communication parameter by the second communication processing function, using the second communication parameter obtained by the communication parameter obtaining function.

13. A program product according to claim 12, wherein the communication parameter transmitting function includes a function of transmitting a search command for searching for the appliance corresponding to the second communication parameter by the second communication processing function, using the second communication parameter obtained via the communication parameter obtaining function, and upon receiving a response to the search command, transmitting the first communication parameter set in the internal network by the second communication processing function, using the second communication parameter obtained by the communication parameter obtaining function.

14. A program product according to claim 13, wherein:
the communication parameter obtaining function includes a function of obtaining appliance information on the appliance corresponding to the second communication parameter together with the second communication parameter from an external network; and
the communication parameter transmitting function further includes a function of, upon receiving a response to the search command, comparing the appliance information received from the appliance transmitting the response with the appliance information obtained from the external network by the communication parameter obtaining function, and in a case where the appliance information obtained from the external network matches with the appliance information, transmitting the first communication parameter set in the internal network by the second communication processing function, using the second communication parameter obtained by the communication parameter obtaining function.

15. A program product according to claim 13, wherein the communication parameter transmitting function includes a function of, when receiving no response to the search command, transmitting, to any of the appliances on the internal network, the second communication parameter obtained by the communication parameter obtaining function and a request command to the effect that the first communication parameter set in the internal network are set to the appliance corresponding to the second communication parameter.

16. A program product according to any one of claims 12, 13, 14, and 15, further comprising a parameter changing function for changing the first parameter set in the internal network,
wherein the parameter changing function includes a function of transmitting the first parameter to be newly set by the second communication processing function, using the second communication parameter of each appliance stored in the memory.

17. A program product for providing a computer of a network-based appliance connected to an internal network with:
a communication parameter storing function of storing a first communication parameter set in the internal network in a memory;
a first communication processing function for communicating with another appliance via the internal network, using a first communication parameter set in the memory;
a second communication processing function for performing direct wireless communication with another appliance without using the internal network, using a second communication parameter set on an appliance basis;
a communication mode setting function for setting which of the first communication processing function and the second communication processing function is used for communication with the appliance;
a communication parameter obtaining function for obtaining the second communication parameter of another appliance from a server apparatus on the internal network by the first communication processing function; and
a communication parameter transmitting function for transmitting the first communication parameter set in the memory to the appliance on the internal network corresponding to the second communication parameter by the second communication processing function, using the second communication parameter obtained by the communication parameter obtaining function.

18. A program product for providing a computer of a network-based appliance having: a communication parameter storing function of storing a first communication parameter set in the internal network in a memory; a first communication processing function for communicating with another appliance via the internal network, using a first communication parameter set in the memory; a second communication processing function for performing direct wireless communication with another appliance without using the internal network, using a second communication parameter set on an appliance basis; and a communication mode setting function for setting which of the first communication processing function and the second communication processing function is used for communication with the appliance, with:
a communication parameter obtaining function for obtaining the second communication parameter of another appliance from a server apparatus on the internal network by the first communication processing function; and
a communication parameter transmitting function for transmitting the first communication parameter stored in the memory to the appliance on the internal network corresponding to the second communication parameter by the second communication processing function, using the first communication parameter obtained by the communication parameter obtaining function.
